(19) United States
(12) Patent Application Publication
(10) Pub. No.: US 2024/0102809 A1
(43) Pub. Date: Mar. 28, 2024

(54) ALLOCATION NOTIFICATION AND GUIDANCE FOR MOBILE DEVICES

(71) Applicants: Kevin M. Repper, Fairfax, VA (US); Marcus A. Strenge, Woodford, VA (US)

(72) Inventors: Kevin M. Repper, Fairfax, VA (US); Marcus A. Strenge, Woodford, VA (US)

(21) Appl. No.: 17/950,457

(22) Filed: Sep. 22, 2022

(51) Int. Cl. G01C 21/34; G06Q 30/06; H04W 4/02

(52) U.S. Cl. CPC G01C 21/3407; G01C 21/3492; G06Q 30/0639; H04W 4/025

(57) ABSTRACT

A notification and guidance for a release of an allocated product utilizing a mobile device. The mobile device is configured to: acquire data originating from a remote computing system, the data including a list of a plurality of identifiers, each of the plurality of identifiers associated with a respective geographical location; determine a global position of the mobile device using the global position system receiver; determine a relative position of the mobile device to the respective geographical locations of more than one identifier of the plurality of identifiers; select at least one selected identifier from the more than one identifier based on the relative position of the mobile device to the respective geographical locations of the more than one identifier; and render the at least one selected identifier on the display.

### FIELD

The present invention relates to allocation of products and more particularly to the notification of the allocation of products and guidance thereof utilizing mobile devices.

### BACKGROUND

Highly allocated products are products that are limited in supply and high in demand. For example, whiskey, such as bourbon, is a popular allocated product in the United States. Allocated whiskeys are whiskeys that are distributed in limited quantities to purchasers, such as liquor stores and distributors, by the distilleries that produce them. What makes them different from any other bourbon is the simple concept of supply and demand. Multiple factors influence both the supply and demand, such as marketing efforts, brand recognition, limited production, and more. However, the result is the same with a list of whiskeys that seemingly everyone wants but are very hard to find.

Typically, private liquor stores raise the prices of allocated whiskeys and thus, an allocated whiskey is more likely to sit on a shelf at a private liquor store. However, certain states in the United States control the sale of alcohol. Alcoholic beverage control (ABC) states include seventeen states that have a monopoly over the wholesaling or retailing of some or all categories of alcoholic beverages, such as beer, wine, and distilled spirits (liquor). The beer, wine, and/or liquor is typically sold at state government run ABC stores. ABC controlled states typically sell the allocated whiskeys at retail price. In these states, whiskey collectors line up at ABC stores when a shipment of allocated whiskey arrives, and almost immediately purchase all of it. Thus, it is very rare for allocated whiskeys to sit on the shelves at ABC stores.

To remedy the above-mentioned issues, some states have come up with new programs to sell allocated whiskeys. For example, Virginia ABC selects random Virginia ABC stores to release allocated whiskeys at particular times and notifies the public of which stores are selling allocated whiskeys. The system works as follows. Virginia ABC stores receive shipments of liquor every week. The allocated liquor that is part of the shipments are labeled such that the ABC store employees hold the allocated liquor in the back of the store and do not place the allocated liquor on the shelves. The allocated liquor builds up over time in the back of the store. When a ‘drop’ occurs, Virginia ABC selects a limited number of random ABC stores to release the allocated liquor for sale to the public. Virginia ABC notifies the particular store, and the ABC store employees setup the allocated liquor in the store for purchase to the public. The public is also notified of the drop by either e-mail or on a social media website or application. The notification includes a list of ABC stores that are part of this particular drop. The patrons then drive to the nearest ABC store that has been authorized to sell the allocated whiskey. Virginia ABC allows each patron to purchase one bottle per store per day of the allocated whiskey.

As one can appreciate, the faster a patron can arrive at the Virginia ABC store that has been authorized to sell the allocated whiskey, the more likely the patron can purchase a more sought after allocated whiskey. Thus, some patrons constantly check their e-mails or the Virginia ABC social media webpages to determine if a drop is occurring at a particular store. If the patrons do not constantly check e-mails and the Virginia ABC social media page, the patron could show up late to the authorized store or completely miss out on a drop.

Accordingly, it would be desirable for an improved notification of patrons when a drop of allocated products occurs and improved guidance to a closest store partaking in said drop.

### SUMMARY

The present invention relates to allocation notification and guidance for mobile devices.

A feature of the present invention is to notify patrons of when an allocated product is being provided at a particular authorized store.

A further feature of the present invention is to guide patrons to an authorized store that is closest in proximity or estimated time of arrival to the patron.

Additional features and advantages of the present invention will be set forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention, in part, relates to a mobile device. The mobile device includes a processor, a memory, a global positioning system receiver, and a user interface including at least a display. The memory has stored therein computer-readable instructions that, upon execution by the processor, configure the mobile device to: (a) acquire data originating from a remote computing system, the data comprising a list of a plurality of identifiers, each of the plurality of identifiers associated with a respective geographical location; (b) determine a global position of the mobile device using the global position system receiver upon receiving the data; (c) determine a relative position of the mobile device to the respective geographical locations of more than one identifier of the plurality of identifiers; (d) select at least one selected identifier from the more than one identifier based on the relative position of the mobile device to the respective geographical locations of the more than one identifier; and (e) render the at least one selected identifier on the display.

The present invention further relates to a non-transitory computer readable medium storing a program causing a processor of a mobile device to execute a process. The process includes the following: acquiring data on a mobile device originating from a remote computing system, the data comprising a list of a plurality of identifiers, each of the plurality of identifiers associated with a respective geographical location; determining a global position of the mobile device using a global position system receiver; determining a relative position of the mobile device to the respective geographical locations of more than one identifier of the plurality of identifiers; selecting at least one selected identifier from the more than one identifier based on the relative position of the mobile device to the respective geographical locations of the more than one identifier; and rendering the at least one selected identifier on a display of the mobile device.

It is to be understood that both the foregoing general description and the following detailed description are exemplary and explanatory only and are intended to provide a further explanation of the present invention, as claimed.

### BRIEF DESCRIPTION OF THE DRAWINGS

FIG. 1 is a schematic view of a wireless communications network that can be utilized by an embodiment of the present invention.

FIG. 2 is a front view of a smartphone having a touchscreen display, wherein the touchscreen display is rendering a plurality of selected identifiers that are selectable by a user.

FIG. 3 is a front view of the smartphone of FIG. 2, wherein the touchscreen display is rendering navigation instructions of a determined route on a roadway system via a navigation software.

FIG. 4 is a flow chart of a process executed by a processor of a mobile device of an embodiment the present invention.

### DETAILED DESCRIPTION

An allocation notification and guidance software for mobile devices is described herein. As mentioned above, a drop is when an entity compiles a list of authorized stores to sell an allocated product, and the public is notified of the authorized stores. According to the present invention, the allocation notification and guidance software is utilized a mobile device. The mobile device acquires data that a drop of allocated products has occurred, determines the nearest store to the mobile device in which a drop has occurred based on the data, and presents the nearest store to the user on the mobile device. Thus, the present invention not only notifies users that a drop has occurred but also provides the closest store to the user such that the user can quickly attend the closest store and purchase the allocated product of choice prior to other patrons.

References herein to “an example” or “a specific example” or “an aspect” or “an embodiment,” or similar phrases, are intended to introduce a feature or features of the present invention, or components thereof, or methods of using or manufacturing the present invention (depending on context), and that can be combined with any combination of previously-described or subsequently-described examples, aspects, embodiments (i.e. features), unless a particular combination of features is mutually exclusive or if context indicates otherwise. Further, as used in this specification, the singular forms “a,” “an,” and “the” include plural referents (e.g. at least one or more) unless the context clearly dictates otherwise.

The present invention includes a software that is run a mobile device. The mobile device includes at least a processor, a memory, a global positioning system receiver, and a user interface having a display. The memory has stored therein computer-readable instructions that, upon execution by the processor, configure the mobile device to perform steps.

The term “mobile device” herein refers to any one or all of cellular telephones, smartphones, personal or mobile multi-media players, personal data assistants (PDA's), laptop computers, tablet computers, smartbooks, palm-top computers, wireless electronic mail receivers, multimedia Internet enabled cellular telephones, wireless gaming controllers, and similar personal electronic devices that include a programmable processor, memory, and transceiver circuitry for conducting communication with remote computing systems.

The term “remote computing system” can be any type of computing device that is remote from the mobile device. For example, the remote computing system can include a server, a cloud-based server, a desktop, a laptop, another mobile device, and any similar electronic devices that include a programmable processor, memory, and transceiver circuitry for conducting communication with the Internet, a plurality of mobile devices, or a combination thereof.

At least one mobile device, such as a plurality of mobile devices, acquires data originating from a remote computing system when a drop occurs. The data originated at the remote computing system can include a list of a plurality of identifiers, each of the plurality of identifiers associated with a respective geographical location. For example, an entity compiles the list of identifiers that identify a specific store that is authorized at that time to sell allocated products, i.e., when a drop occurs. The identifier can be in the form of numbers, letters, other indicia, or a combination thereof. Each of the identifiers is associated with a specific store, and thus is associated with a specific geographic location that the store is located. The specific geographic location of the store can be an address of the store or geographical coordinates of the store.

For exemplary purposes, the following is an example of the data originated by the remote computing system and acquired by the mobile device: The following stores have been authorized to sell any limited availability products in stock: 119, Alexandria; 81, Arlington; 109, Arlington; 94, Ashburn; 73, Ashburn; 327, Blacksburg; 39, Bristow; 125, Charlottesville; 202, Charlottesville; 69, Chesapeake; 79, Chesapeake; 123, Clifton Forge; 124, Covington; 37, Culpeper; 154, Danville; 178, Dillwyn; 144, Emporia; 152, Fannville; 142, Front Royal; 207, Glen Allen; 68, Harrisonburg; 145, Harrisonburg; 184, Harrisonburg; 78, Haymarket; 99, Herndon; 127, Herndon; 192, Kilmarnock; 51, Lake Monticello; 136, Leesburg; 166, Leesburg; 138, Louisa; 117, Lynchburg; 89, Manakin-Sabot; 33, Manassas; 55, Manassas; 133, Manassas; 135, Marion; 88, Marshall; 132, Martinsville; 38, New Kent; 107, Norfolk; 128, Norfolk; 134, Norfolk; 163, Orange; 326, Powhatan; 323, Purcellville; 356, Radford; 101, Richmond; 150, Richmond; 350, Richmond; 115, Roanoke; 59, South Boston; 143, South Hill; 35, Stafford; 122, Staunton; 82, Sterling; 362, Sterling; 198, Tappahannock; 219, Vienna; 98, Virginia Beach; 106, Virginia Beach; 129, Virginia Beach; 188, Virginia Beach; 225, Virginia Beach; 278, Virginia Beach; 336, Virginia Beach; 48, Williamsburg; 148, Williamsburg; 320, Williamsburg; 47, Winchester; 139, Winchester; 408, Zion Crossroads. In this example, a store number is provided and a city in which the store is located is also provided.

As mentioned above, an entity that sells the allocated products publishes the data via the remote computing system. The entity originates the data by first determining which stores are authorized to sell the allocated products and then produce the data in the form of a list of the authorized stores (i.e., a list of a plurality of identifiers). The entity can then directly send the data from the remote computing system to the mobile devices via the Internet or other wireless connection.

In certain embodiments, the entity publishes the data on a website, a social media platform, via e-mail, or a combination thereof. In such embodiments, the program stored on the mobile device configures the processor of the mobile device to recognize when the entity publishes the data and retrieve the published data. For example, if the entity publishes the data including a list of identifiers on a social media page, the mobile device can recognize that a list of identifiers has been published by matching key words, terms, or numbers stored on the memory of the mobile device and retrieve the data from the social media page. If the entity publishes the data including the list of identifiers via e-mail, the mobile device can receive the e-mail and recognize that the e-mail content is a list of identifiers by similarly matching key words, terms, or numbers. The mobile device can then retrieve the data from the e-mail. Once the mobile device receives or retrieves the data, the mobile device has acquired the data.

When the mobile device acquires the data, the mobile device determines a global position of the mobile device using the global position system receiver and determines a relative position of the mobile device to the respective geographical locations of more than one identifier of the plurality of identifiers. For example, the memory of the mobile device can store all of the possible identifiers that exist and their associated geographical locations, i.e., addresses. Using the exemplary data list above, as an example, there can be a total of 1000 stores or more that sell the allocated products. When a drop occurs only some of these 1000 stores or more are authorized to sell the allocated products, such as 50 stores. All of the store's identifiers that participate in the sale of allocated products and their respective addresses can be stored on the memory of the mobile device. Accordingly, when the mobile device acquires the data of the list of authorized stores, the processor of the mobile device can match the numbers provided in the acquired data with the numbers stored in the memory of the mobile device to determine which stores are authorized to sell the allocated products at that point in time.

The processor of the mobile device can then determine a relative position of the mobile device to the respective geographical locations of more than one identifier of the plurality of identifiers that are part of the data by using the addresses stored in the memory. In certain embodiments, the processor can determine the relative position of the mobile device to the respective geographical locations of all of the plurality of identifiers that are part of the data acquired by the mobile device. This can be done via a navigation software loaded on the mobile device.

In other embodiments, a user interface of the mobile device can allow a user to select only certain identifiers (stores) that the processor of the mobile device recognizes and determines the relative position of the mobile device. For example, a user that lives in Fairfax County, Virginia can utilize a user interface on the mobile device that presents all of the stores in Virginia as a list on the display. The user can select the stores from the list that are located within Fairfax County, Virginia, or within a certain radius of the user's home, office, or other area. When the user selects the certain stores, and when a drop occurs, the processor first determines whether any of the selected stores are part of the plurality of identifiers in the data. If one or more of the selected stores is part of the plurality of identifiers, then the processor only determines the relative position of the mobile device to the respective geographical locations of the selected stores of the plurality of identifiers, instead of all of the plurality of identifiers.

After the processor of the mobile device determines a relative position of the mobile device to the respective geographical locations of more than one identifier of the plurality of identifiers, the processor of the mobile device can then select at least one selected identifier from the more than one identifier. The selection is based on the relative position of the mobile device to the respective geographical locations of the more than one identifier.

In certain embodiments, the at least one selected identifier has a respective geographical location that is closest in proximity to the global position of the mobile device as compared to the other of the more than one identifier. For example, the processor can determine a distance from the mobile device to the more than one identifier and select the at least one selected identifier that is closer than any of the other more than one identifier.

In certain embodiments, the mobile device can have navigation software stored on the memory, as mentioned above. In such embodiments, the mobile device can be configured to utilize the navigation software to determine estimated times of arrival from the global position of the mobile device to the respective geographical locations of the more than one identifier based on determined routes of a roadway system on the navigation software. In such embodiments, the processor selects the at least one selected identifier that has the shortest respective estimated time of arrival as compared to the other of the more than one identifier. The navigation software can utilize a live data feed including at least a near live data feed of traffic to determine the estimated times of arrival. A near live data feed can have a delay of 30 seconds, 1 minute, 2 minutes, 3 minutes, 4 minutes, 5 minutes, or more, such as from 30 seconds to 5 minutes, from 1 minute to 4 minutes, or from 2 minutes to 3 minutes.

In some embodiments, the at least one selected identifier is a plurality of selected identifiers. In certain embodiments, the plurality of selected identifiers each have a respective geographical location that is closer in proximity to the global position of the mobile device as compared to the other of the more than one identifier that are not selected. In certain embodiments, the plurality of selected identifiers each have shorter respective estimated times of arrival as compared to the other of the more than one identifier.

The processor of the mobile device renders that at least one selected identifier on the display. When the at least one selected identifier is a plurality of selected identifiers, the plurality of selected identifiers are rendered on the display. In certain embodiments, the plurality of selected identifiers are listed on the display in an order from closest in proximity to the global position of the mobile device to the furthest away in proximity from the global position of the mobile device. In certain embodiments, the plurality of selected identifiers are listed on the display in an order from a shortest respective estimated time of arrival to a longest respective estimated time of arrival, as determined by the navigation software described in detail above.

In certain embodiments, the plurality of selected identifiers listed on the display are user selectable. For example, the display of the mobile device can be a touchscreen in which a user can tap on one of the plurality of selected identifiers for user selection. Upon user selection of one of the plurality of selected identifiers, the mobile device is further configured to render navigation instructions of a determined route on a roadway system via the navigation software. The determined route is from the global position of the mobile device to the respective geographical location of the one of the plurality of selected identifiers that is user selected.

The computer-readable instructions can be part of an application loaded on the memory of the mobile device, for example, an app loaded on a smartphone or tablet. In such embodiments, the application can be configured to initiate a notification on the mobile device when the processor of the mobile device selects the at least one selected identifier from the more than one identifier. The processor can render the notification on the display of the mobile device, notifying the user of the drop and displaying the selected identifier, thereby notifying the user which store is closest or has the shortest estimated time of arrival to the mobile device.

The application can configure the processor of the mobile device to produce the notification on the mobile device when the mobile device is in an idle mode and when the mobile device is in active mode. For example, if the user is actively using the phone, the notification can interrupt the active usage and display the selected identifier to the user. Alternatively, if the user is not using the mobile device, and the mobile device is in a sleep mode or idle mode in which the screen in blank, the application can be configured to activate the phone out of an idle mode and produce the notification on the display of the mobile device.

The notification can include at least a message on the display, the message including the at least one selected identifier or an address of the store associated with the identifier. The notification can further include a sound produced by a speaker of the mobile device, a vibration produced by a vibrator of the mobile device, or a combination thereof. Thus, when a mobile device is in a user's pocket, the user can be notified by a sound, a vibration, or both.

In certain embodiments, the message of the notification is a selectable message that, upon selection by a user, initiates navigation instructions that are presented on the display of the mobile device. The navigation instructions are from the location of the mobile device to the store associated with the selected identifier. For example, when a user taps on the message of the notification using a touch screen of the mobile device, the navigation software can automatically initiate to determine a route and render navigation instructions from the location of the mobile device to the store associated with the selected identifier.

The mobile device can be configured to repeat the steps of determining the closest store when the mobile device is moved a certain distance. For example, if the mobile device is moved more than a quarter mile, more than half a mile, more than three quarters of a mile, more than one mile, more than two miles, more than three miles, or more than four miles, the mobile device can detect the movement and automatically redetermine the closest store. For example, redetermining the closest store can include the following: determine a global position of the mobile device using the global position system receiver; determine a relative position of the mobile device to the respective geographical locations of more than one identifier of the plurality of identifiers; select at least one selected identifier from the more than one identifier based on the relative position of the mobile device to the respective geographical locations of the more than one identifier; and render the at least one selected identifier on the display. In certain embodiments, the application on the mobile device can provide a prompt for a user to manually select that, once selected, initiates the mobile device to redetermine the closest store to the mobile device using the steps mentioned above.

The present invention further includes a non-transitory computer readable medium storing a program causing a processor of a mobile device to execute a process. The process comprises steps of: acquiring data on a mobile device originating from a remote computing system, the data comprising a list of a plurality of identifiers, each of the plurality of identifiers associated with a respective geographical location; determining a global position of the mobile device using a global position system receiver upon receiving the data from the remote computing system; determining a relative position of the mobile device to the respective geographical locations of more than one identifier of the plurality of identifiers; selecting at least one selected identifier from the more than one identifier based on the relative position of the mobile device to the respective geographical locations of the more than one identifier; and rendering the at least one selected identifier on a display of the mobile device.

Embodiments of mobile device described herein improve the functioning of the mobile device by providing notifications and guidance of allocated products via the mobile devices. To do this, the various embodiments use techniques limited to the realm of computer technology, such as global positioning systems, applications on mobile devices, notifications on mobile devices, network accessibility, and the like. Moreover, the present invention utilizes, processes, and distributes data using computer hardware such as processors, memory, network communication hardware, global positioning receivers, and the like. Finally, the problem of a lack of notification and guidance that is being addressed herein is a problem that can only be solved by computer technology.

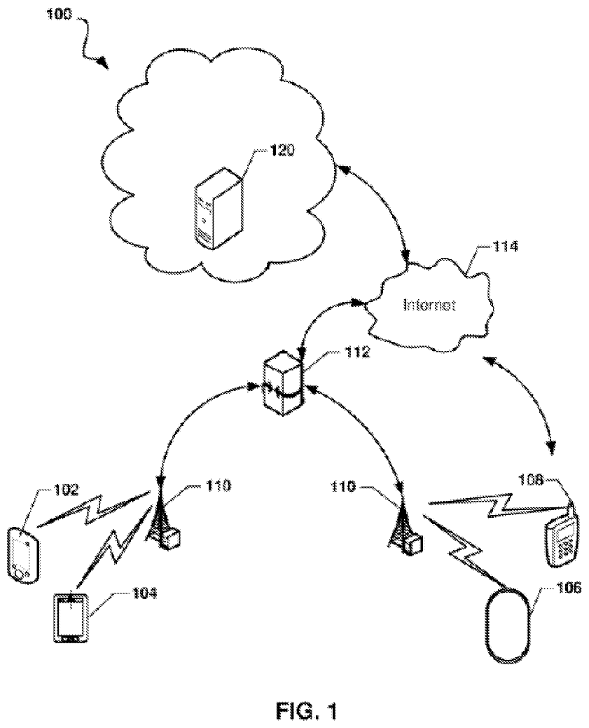

The various embodiments can be implemented within a variety of wireless communication systems 100, an example of which is illustrated in FIG. 1. The communication system 100 can include a plurality of mobile devices 102, 104, 106, 108, that are configured to communicate via cellular telephone network, a radio access network, WiFi network, WiMAX network, and/or other known technologies. Mobile devices 102, 104, 106, 108 can be configured to receive and transmit voice, data and control signals to and from a base station 110 (e.g., base transceiver station) that can be coupled to a controller (e.g., cellular base station, radio network controller, service gateway, etc.) operable to communicate the voice, data, and control signals between mobile devices and to other network destinations.

The base stations 110 can communicate with an access gateway 112. The access gateway can be a packet data serving node (PDSN), for example, and can serve as the primary point of entry and exit of wireless device traffic. The access gateway can be implemented in a single computing device or in many computing devices, either within a single network or across a wide area network, such as the Internet 114.

The access gateway can forward the voice, data, and control signals to other network components as user data packets, provide connectivity to external packet data networks, manage and store contexts (e.g. network internal routing information, etc.) and act as an anchor between different technologies (e.g., 4G and 5G systems). The access gateway can also coordinate the transmission and reception of data to and from the Internet 114, and the transmission and reception of voice, data and control information to and from an external service network connected to the Internet 114 and other base stations 110 and mobile devices 102, 104, 106, 108.

The access gateway 112 can connect the mobile devices 102, 104, 106, 108 to the service network (not shown). The service network can control a number of services for individual subscribers, such as management of billing data and selective transmission of data, such as multimedia data, to a specific mobile device 102, 104, 106, 108. The service network can be implemented in a single computing device or in many computing devices, either within a single network or across a wide area network, such as the Internet 114. The service network can typically include one or more servers, such as a group communication servers.

The mobile device 102, 104, 106, 108 can be, for example, a smartphone 102, 104, a tablet computer 106, a cellular telephone 108, or any other suitable mobile device. In general, the mobile devices can include a platform that can receive and execute software applications, data and/or commands transmitted over the wireless network that can ultimately come from the service network, the Internet 114 and/or other remote servers and networks. The mobile devices 102, 104, 106, 108 can include a transceiver operably coupled to a processor, which can be an application specific integrated circuit (ASIC), microprocessor, logic circuit, or other data processing device. The processor can execute an application programming interface (“API”) layer that interfaces with any resident programs in an internal memory of the mobile device 102, 104, 106, 108. The internal memory can be comprised of read-only or random-access memory (RAM and ROM), EEPROM, flash cards, or any memory common to computer platforms. The mobile device 102, 104, 106, 108 can also include a local database that stores applications not actively used in memory. The local database is typically a flash memory cell but can be any secondary storage device as known in the art, such as magnetic media, EEPROM, optical media, tape, soft, or hard disk, or the like. The processor can also be operably coupled to external devices such as an antenna, microphone, speaker, display, keypad or other user interface, such as a touchscreen device, as is known in the art.

In certain embodiments, the components of the mobile device 102, 104, 106, 108 can be provided in a compact housing (i.e., a “handset”) that enables the device to be held and easily manipulated by a user. The mobile device 102, 104, 106, 108 can also include at least one sensor that generates signals that can be interpreted by the processor to determine the motion, position and/or orientation of the device handset at any given time as is known in the art.

As mentioned above, the present invention can be implemented using the wireless communication systems 100, as shown in FIG. 1. When a drop occurs, an entity that sells the allocated products utilizes a remote computing system 120 that publishes a data packet including a list of a plurality of identifiers via the Internet 114. The list of the plurality of identifiers can be published on the Internet 114 via social media platforms, e-mail, websites, applications, and the like. The mobile device 102, 104, 106, 108 can receive the data packet via the access gateway 112 that transmits the data packets to the base stations 110 from the Internet 114. Alternatively, if the mobile devices 102, 104, 106, 108 are directly connected to the Internet 114 via Wi-Fi or other connection, the mobile devices 102, 104, 106, 108 can receive the data packets directly from the Internet 114.

Once the mobile devices 102, 104, 106, 108 receive the data packet, the processor of the mobile devices 102, 104, 106, 108 performs the steps as mentioned above in detail. For example, the processor determines a global position of the mobile device 102, 104, 106, 108 using the global position system receiver. The processor then determines a relative position of the mobile device to the respective geographical locations of more than one identifier of the plurality of identifiers. The processor then selects at least one selected identifier from the more than one identifier based on the relative position of the mobile device to the respective geographical locations of the more than one identifier and renders the at least one selected identifier on the display of the mobile device 102, 104, 106, 108.

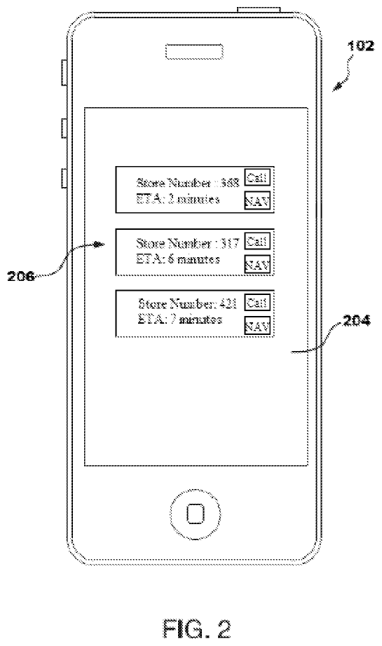

FIG. 2 depicts a smartphone 102 shown in FIG. 1. The smartphone 102 has a touchscreen interface 204. The touchscreen interface 204 allows for the smartphone 102 to receive a user input from the user. As can be seen, the smartphone 102 shown in FIG. 2 has already determined a global position of the smartphone 102 using the global position system receiver, determined a relative position of the smartphone 102 to the respective geographical locations of more than one identifier of the plurality of identifiers, selected a plurality of selected identifiers from the more than one identifier based on the relative position of the smartphone 102 to the respective geographical locations of the more than one identifier, and has rendered three selected identifiers 206 on the touchscreen 204 of the smartphone 102 in an order from shortest estimated time of arrival (ETA) to longest ETA.

The three selected identifiers 206 that are rendered on the touchscreen 204 are in the form of a notification produced by an application loaded on the memory of the smartphone 102. Each of the three selected identifiers show a store number and an ETA based on a route from the location of the smartphone 102 to the respective store. The smartphone 102 utilizes navigation software to determine the estimated times of arrival from the global position of the smartphone 102 to the respective geographical locations of the identifiers based on determined routes of a roadway system on the navigation software. As can be seen, the processor selected the three selected identifiers that have the shortest respective estimated time of arrival as compared to the other identifiers. The navigation software can utilize a live data feed of traffic to determine the estimated times of arrival. The estimated times of arrival can be updated when the smartphone 102 is either moved, or a different amount of traffic is detected.

The three selected identifiers 206 are selectable by the user via the touchscreen 204. When one of the three selected identifiers 206 is selected by the user, the smartphone 102 is further configured to render navigation instructions of a determined route on a roadway system via the navigation software. The determined route is from the global position of the smartphone 102 to the respective geographical location of the selected identifier that is user selected.

Each of the three selected identifiers 206 can also show a call selection (call box) or a navigation selection (NAV box). When a call box is selected by the user using the touchscreen 204, the smartphone 102 is further configured to dial the phone number of the respective store of the respective selected identifier 206. When a NAV box is selected by the user using the touchscreen 204, the smartphone 102 is further configured to render navigation instructions of a determined route on a roadway system via the navigation software of the respective store of the respective selected identifier 206.

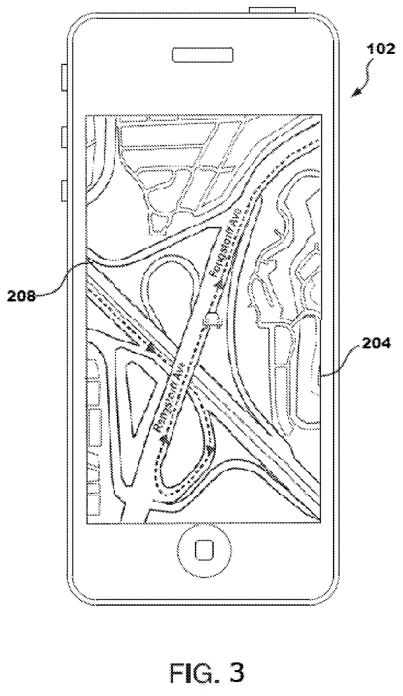

FIG. 3 illustrates the smartphone 102 of FIGS. 1 and 2 with the touchscreen 204. As can be seen, the navigational instructions 208 are rendered on the touchscreen 204 and navigate the user from the smartphones 102 current location to the location of a store associated with the selected identifier that the user selected via the touchscreen 204.

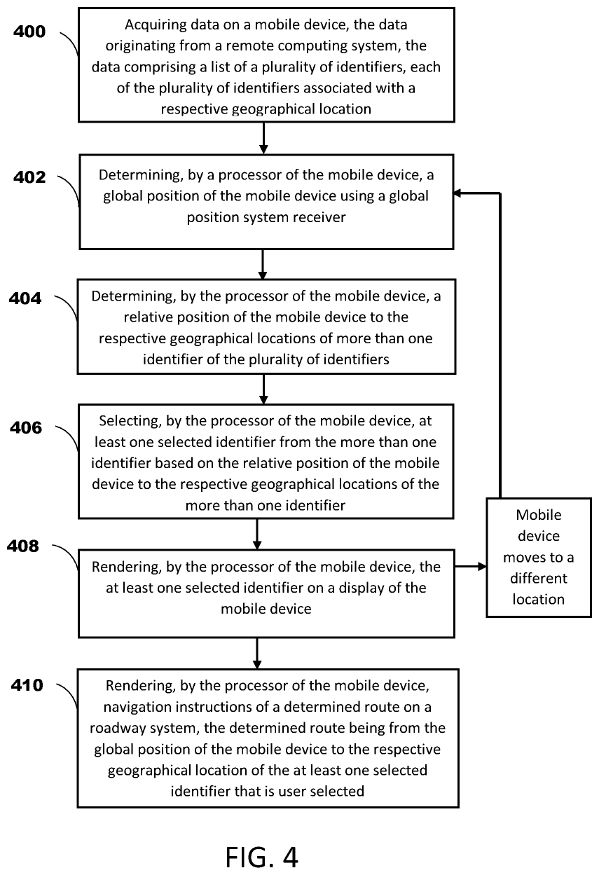

FIG. 4 provides a flow chart of a process of the present invention. As illustrated, the process includes a step of acquiring data on a mobile device, the data originating from a remote computing system, the data comprising a list of a plurality of identifiers, each of the plurality of identifiers associated with a respective geographical location 400. The process further includes a step of determining, by a processor of the mobile device, a global position of the mobile device using a global position system receiver 402. The process further includes a step of determining, by the processor of the mobile device, a relative position of the mobile device to the respective geographical locations of more than one identifier of the plurality of identifiers 404. The process further includes a step of selecting, by the processor of the mobile device, at least one selected identifier from the more than one identifier based on the relative position of the mobile device to the respective geographical locations of the more than one identifier 406. The process further includes a step of rendering, by the processor of the mobile device, the at least one selected identifier on a display of the mobile device 408. When the mobile device moves to a different location, steps 402 through 408 are repeated. When a user selects the at least one selected identifier on the display, the process further includes a step of rendering, by the processor, navigation instructions of a determined route on a roadway system, the determined route being from the global position of the mobile device to the respective geographical location of the at least one selected identifier 410.

The disclosure herein refers to certain illustrated examples, it is to be understood that these examples are presented by way of example and not by way of limitation. The term “about,” as it appears herein, is intended to indicate that the values indicated can vary by plus or minus 5%. The intent of the foregoing detailed description, although discussing exemplary examples, is to be construed to cover all modifications, alternatives, and equivalents of the examples as can fall within the spirit and scope of the invention as defined by the additional disclosure.

The present invention can include any combination of the various features or embodiments described above and/or in the claims below as set forth in sentences and/or paragraphs. Any combination of disclosed features herein is considered part of the present invention and no limitation is intended with respect to combinable features.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A mobile device comprising:
a processor;
a memory;
a global positioning system receiver; and
a user interface comprising at least a display, wherein
the memory has stored therein computer-readable instructions that, upon execution by the processor, configure the mobile device to:
(a) acquire data originating from a remote computing system, the data comprising a list of a plurality of identifiers, each of the plurality of identifiers associated with a respective geographical location;
(b) determine a global position of the mobile device using the global position system receiver;
(c) determine a relative position of the mobile device to the respective geographical locations of more than one identifier of the plurality of identifiers;
(d) select at least one selected identifier from the more than one identifier based on the relative position of the mobile device to the respective geographical locations of the more than one identifier; and
(e) render the at least one selected identifier on the display.

2. The mobile device of claim 1, wherein the at least one selected identifier has a respective geographical location that is closest in proximity to the global position of the mobile device as compared to the other of the more than one identifier.

3. The mobile device of claim 1, wherein step (c) further comprises the mobile device configured to determine estimated times of arrival from the global position of the mobile device to the respective geographical locations of the more than one identifier based on determined routes of a roadway system, wherein the at least one selected identifier has a shortest respective estimated time of arrival as compared to the other of the more than one identifier.

4. The mobile device of claim 3, wherein the estimated times of arrival are further determined by processing a live feed of traffic delay data acquired by the mobile device.

5. The mobile device of claim 1, wherein the at least one selected identifier is a plurality of selected identifiers, and the plurality of selected identifiers are rendered on the display.

6. The mobile device of claim 5, wherein the plurality of selected identifiers have respective geographical locations that are closer in proximity to the global position of the mobile device as compared to the other of the more than one identifier, and the plurality of selected identifiers are listed on the display in an order from closest in proximity to the global position of the mobile device to the furthest away in proximity from the global position of the mobile device.

7. The mobile device of claim 5, wherein
step (c) further comprises the mobile device configured to determine estimated times of arrival from the global position of the mobile device to the respective geographical locations of the more than one identifier based on determined routes of a roadway system, and
the plurality of selected identifiers are listed on the display in an order from a shortest respective estimated time of arrival to a longest respective estimated time of arrival.

8. The mobile device of claim 5, wherein
the plurality of selected identifiers listed on the display are user selectable, and
upon user selection of one of the plurality of selected identifiers, the mobile device is further configured to render navigation instructions of a determined route on a roadway system, the determined route being from the global position of the mobile device to the respective geographical location of the one of the plurality of selected identifiers that is user selected.

9. The mobile device of claim 1, wherein the computer-readable instructions are part of an application loaded on the memory of the mobile device.

10. The mobile device of claim 9, wherein step (e) further comprises the application configured to initiate a notification on the mobile device upon the selection of at least one selected identifier from the more than one identifier by the mobile device.

11. The mobile device of claim 10, wherein the notification is produced on the mobile device when the mobile device is in an idle mode and when the mobile device is in active mode.

12. The mobile device of claim 10, wherein the notification comprises at least a message on the display, the message comprising the at least one selected identifier.

13. The mobile device of claim 12, wherein the notification further comprises a sound produced on a speaker of the mobile device, a vibration produced by a vibrator of the mobile device, or a combination thereof.

14. The mobile device of claim 10, wherein the at least one selected identifier is a plurality of selected identifiers that are each user selectable by at least one respective selection box.

15. The mobile device of claim 14, wherein the at least one selection box is two selection boxes comprising a navigation selection box and a call selection box, wherein upon selection of the navigation selection box, the mobile device is further configured to render navigation instructions of a determined route on a roadway system, the determined route being from the global position of the mobile device to the respective geographical location of one of the plurality of selected identifiers that is user selected, and upon selection of the call selection box, the mobile device is further configured to dial a phone number of the one of the plurality of selected identifiers that is user selected.

16. The mobile device of claim 1, wherein when the mobile device is moved from the global position, the mobile device is configured to automatically perform steps (b) through (e) again.

17. A non-transitory computer readable medium storing a program causing a processor of a bile device to execute a process, the process comprising:
a) acquiring data from a remote computing system, the data comprising a list of a plurality of identifiers, each of the plurality of identifiers associated with a respective geographical location;
b) determining a global position of the mobile device using a global position system receiver;
c) determining a relative position of the mobile device to the respective geographical locations of more than one identifier of the plurality of identifier;
d) selecting at least one selected identifier from the more than one identifier based on the relative position of the mobile device to the respective geographical locations of the more than one identifier; and
e) rendering the at least one selected identifier on a display of the mobile device.

18. The process of claim 17, wherein, upon user selection of the at least one selected identifier, the process further comprises a step of: f) rendering navigation instructions of a determined route on a roadway system, the determined route being from the global position of the mobile device to the respective geographical location of the at least one selected identifier that is user selected.

19. The process of claim 17, wherein when the mobile device is moved from the global position, the process further comprises repeating steps (b) through (e) again.

20. The process of claim 17, wherein step (c) further comprises determining estimated times of arrival from the global position of the mobile device to the respective geographical locations of the more than one identifier based on determined routes of a roadway system.
